(19) United States
(12) Patent Application Publication
(10) Pub. No.: US 2010/0323941 A1
(43) Pub. Date: Dec. 23, 2010

(54) Automatic Dishwashing Detergent

(75) Inventors: E. Van Vlahakis, Huntington Beach, CA (US); Dina Alrashawi, Huntington Beach, CA (US)

Correspondence Address: MCDERMOTT, WILL & EMERY LLP;Attn: IP Department, 227 WEST MONROE STREET, SUITE 4400, CHICAGO, IL, 60606-5096, US

(73) Assignee: VENUS LABORATORIES, INC., Wood Dale, IL (US)

(21) Appl. No.: 12/486,402

(22) Filed: Jun. 17, 2009

(51) Int. Cl. C11D 3/386

(52) U.S. Cl. 510/226; 510/220

(57) ABSTRACT

An automatic dishwashing detergent, comprising, by weight: 2-10% sodium citrate dehydrate; 0.5 to 2.0% citric acid; 0.5 to 10.0% of a first surfactant, 0.8 to 1.1% xanthan gum; 0.1 to 5.0% of an enzyme; 0.5 to 10.0% of a second surfactant; and the balance being water. The dishwashing detergent can optionally include a preservative and/or an essential oil.

### TECHNICAL FIELD

The invention is directed to automatic dishwashing detergents comprising sodium citrate dehydrate; a thickener, such as xanthan gum; at least one, and preferably two, surfactants; an organic acid, preferably citric acid, as a cleaning and thickening agent; and an enzyme. The detergent in accordance with the invention may also include an essential oil, to impart a pleasant scent into the dishwashing detergent; and a small amount of a preservative, to ensure that the product has a suitably long shelf life. The invention combines favorable characteristics, such as low foaming, high cleansing capabilities, and an environmentally friendly formulation.

### BACKGROUND OF THE INVENTION

Automatic dishwashing detergents are well-known in the art. Most of the automatic dishwashing detergents currently available are suitable for their intended purposes, i.e., effectively cleaning, and leaving previously soiled eating and cooking utensils in a generally spot-free, clean condition.

Known automatic dishwashing detergents contain some combination of one or more of three ingredients, including bleach, caustic, and phosphates. These substances can be deleterious, for various reasons.

For example, phosphates are minerals that act as water softeners and are considered by some to be among the worst pollutants found in detergents. Phosphates are a nutrient, and act as a fertilizer for algae. Thus, when large amounts of phosphates enter waterways, excessive algae growth occurs. This causes odors and creates hypoxic conditions.

Some states have banned the use of phosphates in all detergents, other than automatic dishwasher detergents. Thus, phosphate-free general purpose detergents and clothing detergents are readily available.

Caustic, such as sodium hydroxide (NaOH), sodium borate, potassium hydroxide, and other similar compounds, are also considered to be contaminants of groundwater. Alumina plants use and discharge caustic into the groundwater adjacent their plants. The resulting groundwater contamination is deemed a significant environmental problem. Moreover, the caustic can impart to the automatic dishwashing detergent a noticeable, “choking-type” odor. In addition, an irreversible cloudy film can be etched onto the surface of glassware that has been repeatedly washed with caustic-containing automatic dishwashing detergents.

Bleach provides automatic dishwashing detergents with some disinfecting capabilities. While bleach in groundwater is not generally deemed to be deleterious, the removal of bleach from an automatic dishwashing detergent would lower its cost. Bleach, when combined with caustic, can contribute to the choking-type odor perceptible in certain prior automatic dishwashing detergent products.

It would be desirable to provide an automatic dishwashing detergent which is free of phosphates. It would further be desirable to provide an automatic dishwashing detergent which is free of caustic. Finally, it would be desirable to provide an automatic dishwashing detergent which is both biodegradable, and free of bleach, 1,4-dioxane, formaldehyde, petrochemicals, chlorine and other halogenated compounds, ammonia, and genetically modified organisms (GMOs).

### SUMMARY OF THE INVENTION

The invention is a gel-type automatic dishwashing detergent that has significant advantages over many prior automatic dishwashing detergents. The automatic dishwashing detergent in accordance with the invention is biodegradeable. It has been found that the most preferred embodiment of the invention is especially effective in removing coffee and tea stains.

In addition, the gel-type dishwashing detergent in accordance with the invention is free of many substances and chemicals that are becoming increasingly scarce and expensive, or that are deemed harmful to the environment or toxic to individuals. The present dishwashing detergent is completely devoid of 1,4-dioxane, formaldehyde, phosphates of any kind, petrochemicals, chlorine, ammonia, sodium hydroxide (caustic), and genetically modified organisms (GMOs).

The product is a clear gel, and when used in the concentrations called for, has a neutral pH.

A preferred embodiment of the automatic dishwashing detergent of the invention includes a surface cleaner; a thickener; a pair of surfactants; an aqueous essential oil, to provide the detergent with a pleasing odor; an organic acid, as a cleaning agent and thickener; an enzyme; a preservative; and the balance, deionized water.

However, while a preferred embodiment of the invention includes these components, the broadest aspect of the invention does not necessarily include all of these components. In fact, the broadest aspect of the invention is limited only by the patent claims of the present invention, and the equivalents of those claims.

### DETAILED DESCRIPTION OF PREFERRED EMBODIMENTS

Preferred embodiments of the invention are described below. This invention may, however, be embodied in many different forms, and should not be construed as limited to the embodiments described below. Instead, these embodiments are provided so that this disclosure will be enabling, and provide the reader with the most preferred embodiments of the invention.

The Examples below use sodium citrate di-hydrate, USP. Sodium citrate di-hydrate is available from Univear USA Inc, 17425 NE Union Hill Road, Redmond, Wash. 98052. Sodium citrate di-hydrate is also known as trisodium citrate. The CAS number of sodium citrate di-hydrate is 6132-04-3. Sodium citrate acts as a water softener and as a cleaner. In the present invention, sodium citrate di-hydrate may be used in amounts of between 2-10%, by weight, inclusive.

The Examples below also use a food grade xanthan gum, as a thickener. A preferred xanthan gum is available from Westco Chemicals, Inc., 12551-61 Saticoy Street South, North Hollywood, Calif. 91605. The CAS number of xanthan gum is 11138-66-2. In the present invention, xanthan gum may be used in amounts of between 0.8 and 1.1%, by weight, inclusive.

Furthermore, the Examples below may use Colesoft™ CO as a first surfactant. Colesoft™ CO is a water solution of n-cocoamidopropyldimethylamine oxide, and is available from Trichromatic West, Inc. The CAS number of n-cocoamidopropyl-dimethylamine oxide is 68155-09-9. This first surfactant may be used in amounts of between 0.5% and 10.0%, by weight, inclusive.

The Examples below may further use Dehypon® LS-54 as a second surfactant. Dehypon® LS-54 is said by its manufacturer to be a combination of C12 to C14 ethoxylated and propoxylated fatty alcohols, and more particularly a combination of propoxylated, ethoxylated lauryl- and myristyl alcohols. Dehypon® LS-54 is available from Cognis Corporation, 5051 Estecreek Drive, Cincinnati, Ohio 45232-1446. The CAS number of Dehypon LS-54 is 68439-51-0. This second surfactant may be used in amounts of between 0.5 and 10.0%, by weight, inclusive.

The Examples below may further include citric acid, as a cleaning agent and thickener. A preferred form of citric acid is an anhydrous powdered citric acid. This anhydrous powdered citric acid is available from Dharma Trading Co., 654 Irwin St., San Rafael, Calif. 94901. The CAS number of this citric acid is 77-92-9. Citric acid should be used in the preferred examples in amounts of between 0.5 and 2.0%, by weight, inclusive.

The Examples below may further include an enzyme. A preferred form of enzyme is a protease enzyme, sold under the name Tricozyme ML-3. This enzyme is available from Trichromatic-West, Inc., 6070 Rickenbacker Road, Commerce, Calif. The CAS number of the Tricozyme ML-3 enzyme is 9014-01-1. In the preferred embodiments of the invention, the enzyme should be used in amounts of between 0.1 and 5.0%, by weight, inclusive.

The Examples below may include a preservative. A preferred preservative is 2-phenoxyethanol, available from Clariant Corporation, 4000 Monroe Street, Charlotte, N.C. 28205. The preservative content of the compositions in accordance with the present invention should be approximately 0.2% by weight. Nominally larger amounts of preservative, while not necessary, will not harm the detergents in accordance with the invention.

Finally, in order to give the dishwashing detergent a pleasing scent, a fragrance is often added. The fragrance provides the automatic dishwashing detergent with aesthetically pleasing characteristics. Lavender oil is an optional preferred fragrance for use with the dishwashing detergent in accordance with the invention, and amounts of 0.05% by weight are generally deemed sufficient for these purposes. The particular lavender oil used in accordance with this invention is available from Citrus and Allied Service, Inc.

The following Examples are preferred, but not limiting, embodiments of the invention:

### EXAMPLE 1

One preferred example of a liquid form of a dishwashing detergent in accordance with the invention is described below. The liquid dishwashing detergent of this preferred embodiment is made by blending together several separate phases. In the present example, a one-hundred pound batch is manufactured.

Phase 1 comprises three ingredients: deionized water, sodium citrate di-hydrate and citric acid. In this preferred embodiment, Phase 1 comprises 92.98 pounds of deionized water; 2.0 pounds of sodium citrate di-hydrate USP; and 0.5 pounds of citric acid.

The deionized water is placed in an appropriately sized Pyrex® brand or other similar inert glass container. Sodium citrate di-hydrate is added to the deionized water, and blended with suitable mechanical mixer, under mild agitation conditions, until the sodium citrate di-hydrate dissolves.

Next, the citric acid is blended in, with mild agitation, until it dissolves.

This entire mixture is then blended in the first Pyrex® container for an additional period of time, i.e., approximately fifteen (15) minutes. This step completes the manufacture of Phase 1 of this Example 1.

After the above Phase 1 has been completed, Phase 2 is formulated, but in a second Pyrex® container. This Phase 2 formulation comprises three ingredients, particularly, a first surfactant, a second surfactant, and a thickener.

In this preferred embodiment, 0.5 pounds of a first surfactant, Colesoft™ CO surfactant, is added to 3.0 pounds of a second surfactant, Dehypon® LS-54. These two surfactants are gently agitated with a mechanical mixer for at least three (3) minutes, or until the blend of surfactants has a uniform appearance.

Thereafter, 0.8 pounds of food grade xanthan gum is added, as a thickener. The xanthan gum is blended gently with mechanical agitation until it totally dissolves in the two-surfactant blend. In this embodiment, such dissolution typically takes approximately twenty (20) minutes. This step completes the manufacture of Phase 2 of the composition of this Example 1.

Next, Phase 2 is added into the container containing Phase 1. Thereafter, the combined Phase 1/Phase 2 is blended, with gentle mechanical agitation, for approximately twenty (20) to twenty-five (25) minutes.

After this, three ingredients are added to the Phase 1/Phase 2 combination in order to complete the composition of Example 1.

First, with mechanical stirring, a small amount (0.02 pounds) of lavender oil (an essential oil) are added to the Phase 1/Phase 2 blend.

Next, with the mechanical stirring continuing, 0.1 pounds of the preservative 2-phenoxyethanol are added.

Finally, with the mechanical stirring continuing, 0.1 pounds of the enzyme, Tricozyme ML-3, are added. Mechanical agitation continues for approximately sixty (60) minutes.

This completes the manufacture of the preferred embodiment of the invention in accordance with this Example 1. This formulation has a neutral pH.

### EXAMPLE 2

Described in this Example 2 is another preferred embodiment of the invention.

Again, in this Example 2, Phase 1 comprises three ingredients: deionized water, sodium citrate dehydrate and citric acid. In this embodiment, Phase 1 comprises 81.9 pounds of deionized water; 8.0 pounds of sodium citrate dihydrate USP; and 1.5 pounds of citric acid.

The deionized water is placed in an appropriately sized Pyrex® brand or other similar inert glass container. Sodium citrate di-hydrate is added to the deionized water, and blended with suitable mechanical mixer, under mild agitation conditions, until the sodium citrate di-hydrate dissolves.

Next, the citric acid is blended in, with mild agitation, until it dissolves.

This entire mixture is then blended in the first Pyrex® container for an additional period of time, i.e., approximately fifteen (15) minutes. This step completes the manufacture of Phase 1 of this Example 1.

After the above Phase 1 has been completed, instead of formulating Phase 2, the essential oil and the preservative are added to Phase 1.

Particularly, with mechanical stirring, a small amount (0.05 pounds) of lavender oil (an essential oil) is added to this Phase 1.

Next, with the mechanical stirring continuing, 0.25 pounds of the preservative 2-phenoxyethanol are added to this Phase 1.

Now, Phase 2 may be formulated, again in a second Pyrex® container. This Phase 2 formulation again comprises the same three ingredients, particularly, a first surfactant, a second surfactant, and a thickener.

In this preferred embodiment, 3.5 pounds of a first surfactant, Colesoft™ CO surfactant, is added to 3.5 pounds of a second surfactant, Dehypon® LS-54. These two surfactants are gently agitated with a mechanical mixer for at least three (3) minutes, or until the blend of surfactants has a uniform appearance.

Thereafter, 1.0 pounds of food grade xanthan gum is added, as a thickener. The xanthan gum is blended gently with mechanical agitation until it totally dissolves in the two-surfactant blend. In this embodiment, such dissolution typically takes approximately twenty (20) minutes. This step completes the manufacture of Phase 2 of the composition of this Example 2.

Next, Phase 2 is added into the container containing Phase 1, including the lavender oil and preservative. Thereafter, the combined Phase 1/Phase 2 is blended, with gentle mechanical agitation, for approximately twenty (20) to twenty-five (25) minutes.

After this, the single remaining ingredient is added to the Phase 1/Phase 2 combination in order to complete the composition of Example 2.

Particularly, with the mechanical stirring continuing, 0.3 pounds of the enzyme, Tricozyme ML-3, are added. Mechanical agitation continues for approximately sixty (60) minutes.

This completes the manufacture of the preferred embodiment of the invention in accordance with this Example 2. As with the formulation of Example 1, this Example 2 formulation has a neutral pH.

### EXAMPLE 3

Described in this Example 3 is another preferred embodiment of the invention.

Again, in this Example 3, Phase 1 comprises three ingredients: deionized water, sodium citrate dehydrate and citric acid. In this embodiment, Phase 1 comprises 61.3 pounds of deionized water; 10 pounds of sodium citrate dihydrate USP; and 2.0 pounds of citric acid.

The deionized water is placed in an appropriately sized Pyrex® brand or other similar inert glass container. Sodium citrate di-hydrate is added to the deionized water, and blended with suitable mechanical mixer, under mild agitation conditions, until the sodium citrate di-hydrate dissolves.

Next, the citric acid is blended in, with mild agitation, until it dissolves.

This entire mixture is then blended in the first Pyrex® container for an additional period of time, i.e., approximately fifteen (15) minutes. This step completes the manufacture of Phase 1 of this Example 1.

After the above Phase 1 has been completed, instead of formulating Phase 2, the essential oil and the preservative are added to Phase 1.

Particularly, with mechanical stirring, a small amount (0.1 pounds) of lavender oil (an optional essential oil) is added to this Phase 1.

Next, with the mechanical stirring continuing, 0.5 pounds of the preservative 2-phenoxyethanol are added to this Phase 1.

Now, Phase 2 may be formulated, again in a second Pyrex® container. This Phase 2 formulation again comprises the same three ingredients, particularly, a first surfactant, a second surfactant, and a thickener.

In this preferred embodiment, 10.0 pounds of a first surfactant, Colesoft™ CO, is added to 10.0 pounds of a second surfactant, Dehypon® LS-54. These two surfactants are gently agitated with a mechanical mixer for at least three (3) minutes, or until the blend of surfactants has a uniform appearance.

Thereafter, 1.1 pounds of food grade xanthan gum is added, as a thickener. The xanthan gum is blended gently with mechanical agitation until it totally dissolves in the two-surfactant blend. In this embodiment, such dissolution typically takes approximately twenty (20) minutes. This step completes the manufacture of Phase 2 of the composition of this Example 3.

Next, Phase 2 is added into the container containing Phase 1, including the lavender oil and preservative. Thereafter, the combined Phase 1/Phase 2 is blended, with gentle mechanical agitation, for approximately twenty (20) to twenty-five (25) minutes.

After this, the single remaining ingredient is added to the Phase 1/Phase 2 combination in order to complete the composition of Example 3.

Particularly, with the mechanical stirring continuing, 5.0 pounds of the enzyme, Tricozyme ML-3, are added. Mechanical agitation continues for approximately sixty (60) minutes.

This completes the manufacture of this embodiment of the invention in accordance with this Example 3. As with the formulation of Example 1, this Example 3 formulation has a neutral pH.

### EXAMPLE 4

Described in this Example 4 is the most preferred embodiment of the invention.

Again, in this Example 4, Phase 1 comprises three ingredients: deionized water, sodium citrate dehydrate and citric acid. In this embodiment, Phase 1 comprises 86.95 pounds of deionized water; 7.0 pounds of sodium citrate dihydrate USP; and 1.0 pounds of citric acid.

The deionized water is placed in an appropriately sized Pyrex® brand or other similar inert glass container. Sodium citrate di-hydrate is added to the deionized water, and blended with suitable mechanical mixer, under mild agitation conditions, until the sodium citrate di-hydrate dissolves.

Next, the citric acid is blended in, with mild agitation, until it dissolves.

This entire mixture is then blended in the first Pyrex® container for an additional period of time, i.e., approximately fifteen (15) minutes. This step completes the manufacture of Phase 1 of this Example 1.

After the above Phase 1 has been completed, instead of formulating Phase 2, the essential oil and the preservative are added to Phase 1.

Particularly, with mechanical stirring, a small amount (0.05 pounds) of lavender oil (an optional essential oil) is added to this Phase 1.

Next, with the mechanical stirring continuing, 0.2 pounds of the preservative 2-phenoxyethanol are added to this Phase 1.

Now, Phase 2 may be formulated, again in a second Pyrex® container. This Phase 2 formulation again comprises the same three ingredients, particularly, a first surfactant, a second surfactant, and a thickener.

In this preferred embodiment, 1.0 pounds of a first surfactant, Colesoft™ CO surfactant, is added to 2.5 pounds of a second surfactant, Dehypon® LS-54. These two surfactants are gently agitated with a mechanical mixer for at least three (3) minutes, or until the blend of surfactants has a uniform appearance.

Thereafter, 0.9 pounds of food grade xanthan gum is added, as a thickener. The xanthan gum is blended gently with mechanical agitation until it totally dissolves in the two-surfactant blend. In this embodiment, such dissolution typically takes approximately twenty (20) minutes. This step completes the manufacture of Phase 2 of the composition of this Example 4.

Next, Phase 2 is added into the container containing Phase 1, including the lavender oil and preservative. Thereafter, the combined Phase 1/Phase 2 is blended, with gentle mechanical agitation, for approximately twenty (20) to twenty-five (25) minutes.

After this, the single remaining ingredient is added to the Phase 1/Phase 2 combination in order to complete the composition of Example 4.

Particularly, with the mechanical stirring continuing, 0.4 pounds of the enzyme, Tricozyme ML-3, are added. Mechanical agitation continues for approximately sixty (60) minutes.

This completes the manufacture of the most preferred embodiment of the invention in accordance with this Example 4. As with the formulation of Example 1, this Example 4 formulation has a neutral pH.

What is claimed is:

1. An automatic dishwashing detergent, comprising: sodium citrate di-hydrate citric acid; ethanol; a first surfactant, a second surfactant; a thickener; an enzyme; and the balance being water.

2. (canceled)

3. The automatic dishwashing detergent of claim 2, wherein said automatic dishwashing detergent further comprises a preservative.

4. The automatic dishwashing detergent of claim 3, wherein said automatic dishwashing detergent further comprises an essential oil.

5. The automatic dishwashing detergent of claim 1, wherein said automatic dishwashing detergent is devoid of bleach.

6. The automatic dishwashing detergent of claim 1, wherein said automatic dishwashing detergent is devoid of phosphates.

7. The automatic dishwashing detergent of claim 1, wherein said automatic dishwashing detergent is devoid of formaldehyde.

8. The automatic dishwashing detergent of claim 1, wherein said automatic dishwashing detergent is devoid of caustic.

9. The automatic dishwashing detergent of claim 1, wherein said automatic dishwashing detergent is devoid of ammonia.

10. The automatic dishwashing detergent of claim 1, wherein said automatic dishwashing detergent is devoid of halogenated compounds.

11. An automatic dishwashing detergent, comprising, by weight: 2-10% sodium citrate di-hydrate; 0.5 to 2.0% citric acid; 0.5 to 10.0% of a first surfactant, 0.5 to 10.0% of a second surfactant; 0.8 to 1.1% xanthan gum; 0.1 to 5.0% of an enzyme; and the balance being water.

12. (canceled)

13. The automatic dishwashing detergent of claim 12, wherein said automatic dishwashing detergent further comprises a preservative.

14. The automatic dishwashing detergent of claim 13, wherein said automatic dishwashing detergent further comprises an essential oil

15. The automatic dishwashing detergent of claim 11, wherein said first surfactant is an n-cocoamidopropyl dimethylamine oxide.

16. The automatic dishwashing detergent of claim 12, wherein said second surfactant further comprises a combination of propoxylated, ethoxylated lauryl- and myristyl alcohols.

17. The automatic dishwashing detergent of claim 11, wherein said enzyme is a protease enzyme.

18. (canceled)

19. (canceled)

20. An automatic dishwashing detergent, comprising, by weight: 2-10% Group I citrate di-hydrate; 0.5 to 2.0% of an organic acid; 0.5 to 10.0% of a first surfactant, 0.5 to 10.0% of a second surfactant; 0.8 to 1.1% xanthan gum; 0.1 to 5.0% of a protease enzyme; and the balance being water.

21. An automatic dishwashing detergent, comprising, by weight: 2-10% Group I sodium citrate di-hydrate; 0.5 to 2.0% of a citric acid; 0.5 to 5.0% of a first surfactant, 0.5 to 5.0% of a second surfactant; 0.8 to 1.1% xanthan gum; 0.1 to 2.0% of a protease enzyme; and the balance being water.

22. An automatic dishwashing detergent, comprising, by weight: 2-10% Group I citrate di-hydrate; 0.5 to 2.0% of an organic acid; 0.5 to 10.0% of a first surfactant, 0.5 to 10.0% of a second surfactant; 0.8 to 1.1% xanthan gum; 0.1 to 5.0% of a protease enzyme; and the balance being water.

23. An automatic dishwashing detergent, comprising, by weight: 7% Group I sodium citrate di-hydrate; 1% of a citric acid; 1% of a first surfactant, 0.5 to 10.0% of a second surfactant; 0.9% xanthan gum; 0.4% of a protease enzyme; and the balance being water.

24. An automatic dishwashing detergent, comprising, by weight: 2-10% Group I sodium citrate di-hydrate; 0.5 to 2.0% of a citric acid; 0.5 to 10.0% of a first surfactant, 0.5 to 10.0% of a second surfactant; 0.8 to 1.1% xanthan gum; 0.1 to 5.0% of a protease enzyme; and the balance being water.
